(19) United States
(12) Patent Application Publication
(10) Pub. No.: US 2009/0251031 A1
(43) Pub. Date: Oct. 8, 2009

(54) SECTIONAL CABINET

(75) Inventor: Henry CHEN, Taipei (TW)

Correspondence Address: WPAT, PC, 7225 BEVERLY ST., ANNANDALE, VA, 22003, US

(73) Assignee: PROTREND CO., LTD., Taipei (TW)

(21) Appl. No.: 12/062,813

(22) Filed: Apr. 4, 2008

(51) Int. Cl. A47B 87/00; F16B 12/00

(52) U.S. Cl. 312/108; 312/111; 312/263; 312/265.5

(57) ABSTRACT

A sectional cabinet is assembled from a bottom, a top, a rear wall, a left, and a right wall. The bottom wall is provided on an upper side along rear, left, and right sides with a groove each for the lower sides of the rear, left, and right walls to insert therein, and the top wall is provided on a lower side along rear, left, and right sides with a groove each for the upper sides of the rear, left, and right walls to insert therein. Locating dowels are extended into dowel holes provided on the rear, left, and right sides of the bottom and top walls, as well as through holes provided on lower and upper sides of the rear, left, and right walls, so as to secure the rear, left, and right walls to the bottom and top walls. No tools are needed in assembling the sectional cabinet.

### FIELD OF THE INVENTION

The present invention relates to a sectional cabinet, and more particularly to a sectional cabinet that can be conveniently assembled without the need of any tool.

### BACKGROUND OF THE INVENTION

People use different types of cabinets and closets to store and organize different articles, lest the articles should be disorderly scattered here and there. Most of the currently available cabinets and closets are made of wooden materials. Wooden cabinets and closets have beautiful and changeful appearances but relatively complicated structures, and are therefore not easy to assemble and disassemble. Professional workers are usually required to assemble or disassemble the wooden cabinets and closets. Moreover, wooden cabinets and closets are heavy and therefore could not be conveniently moved and transported.

There are also plastic cabinets and closets available in the market. Since the plastic cabinets and closets have relatively weak structural strength, they usually have relatively small dimensions for storing only articles with smaller sizes. And, the plastic cabinets and closets with small dimensions can only hold less quantities and types of articles, and are therefore not ideal for use.

There are also sectional metal cabinets and closets available in the market. To assemble these sectional metal cabinets and closets, fasteners such as screws and bolts are needed to lock different parts of the sectional cabinets and closets to one another. Tools are required to tighten or loosen the fasteners, so that a lot of time and labor is required to assemble and disassemble the currently available sectional metal cabinets and closets.

It is therefore tried by the inventor to develop an improved sectional cabinet that has simple structure to enable easy assembly and disassembly thereof.

### SUMMARY OF THE INVENTION

A primary object of the present invention is to provide a sectional cabinet that can be conveniently assembled without the need of any tool.

Another object of the present invention is to provide a sectional cabinet that can be conveniently assembled from rear, left, and right walls having lower and upper sides inserted in grooves provided on a bottom and a top wall.

To achieve the above objects, the sectional cabinet according to the present invention includes a bottom, a top, a rear wall, a left, and a right wall. The bottom wall is provided on an upper side along rear, left, and right sides with a groove each for the lower sides of the rear, left, and right walls to insert therein, and the top wall is provided on a lower side along rear, left, and right sides with a groove each for the upper sides of the rear, left, and right walls to insert therein.

In the present invention, locating dowels are extended into dowel holes provided on the rear, left, and right sides of the bottom and top walls, as well as through holes provided on lower and upper sides of the rear, left, and right walls, so as to secure the rear, left, and right walls to the bottom and top walls.

In the present invention, the rear wall is provided on an inner side thereof with at least two spaced U-sectioned vertical posts to increase the structural strength of the rear wall. Lower and upper ends of the U-sectioned vertical posts are separately inserted in the rear grooves on the bottom and the top wall, respectively. The U-sectioned vertical posts on the rear wall are provided on a front side thereof with at least one vertical row of hanging holes, into which supporting brackets may be inserted for supporting different types of shelves thereon.

In the present invention, the left and right walls are provided on respective inner side with two spaced U-sectioned vertical posts to increase the structural strength thereof. Lower and upper ends of the two U-sectioned vertical posts on the left wall being separately inserted in the left grooves on the bottom wall and the top wall, respectively; and lower and upper ends of the two U-sectioned vertical posts on the right wall being separately inserted in the right grooves on the bottom wall and the top wall, respectively. The U-sectioned vertical posts on the left wall and the right wall being correspondingly provided on front sides facing toward one another with at least one hanging hole each. At least two rails are separately mounted to the left and the right wall with two ends of each rail connected to two hanging holes formed at the same height on the same wall. And a drawer may be slidably supported on the at least two rails.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a sectional cabinet according to a preferred embodiment of the present invention viewed from a front side thereof;

FIG. 2 is a top perspective view of a bottom wall for the sectional cabinet of the present invention viewed from a front side thereof;

FIG. 3 is a bottom perspective view of the bottom wall of FIG. 2 viewed from a rear side thereof;

FIG. 4 is a top perspective view of a top wall for the sectional cabinet of the present invention viewed from a front side thereof;

FIG. 5 is a bottom perspective view of the top wall of FIG. 4 viewed from a rear side thereof;

FIG. 6 is a sectioned front view of FIG. 1;

FIG. 7 is a cross sectional view taken along line 7-7 of FIG. 6;

FIG. 7-1 is an enlarged view of the circled area A of FIG. 7;

FIG. 7-2 is an enlarged view of the circled area B of FIG. 7;

FIG. 8 is a cross sectional view taken along line 8-8 of FIG. 6;

FIG. 9 is a front perspective view of a rear wall for the sectional cabinet of the present invention;

FIG. 10 is a perspective view of a left wall for the sectional cabinet of the present invention viewed from an inner side thereof;

FIG. 11 is a perspective view of a right wall for the sectional cabinet of the present invention viewed from an inner side thereof;

FIG. 12 is a perspective view of a connector for connecting two adjacent walls of the sectional cabinet of the present invention;

FIG. 13 shows the use of locating dowels to secure the right wall to the bottom and top walls of the sectional cabinet of the present invention;

FIG. 14 shows the sectional cabinet of the present invention with a shelf mounted therein;

FIG. 15 shows the sectional cabinet of the present invention with two doors mounted to an open front side thereof;

FIG. 16 shows an inner side of the door for the sectional cabinet of the present invention;

FIG. 17 is a fragmentary vertical sectional view of the door of FIG. 16 showing the hanging of hanger and basket thereto;

FIG. 18 shows the sectional cabinet of the present invention with rails mounted to left and right walls thereof;

FIG. 19 shows the sectional cabinet of the present invention of FIG. 18 with drawers mounted thereto;

FIG. 20 is a fragmentary and enlarged sectional view showing the mounting of feet to the bottom wall of the sectional cabinet of the present invention;

FIG. 21 is a fragmentary and enlarged sectional view showing two vertically stacked sectional cabinets of the present invention are tightened together using locating screws; and

FIG. 22 is a perspective view of another sectional cabinet according to a second embodiment of the present invention.

### DETAILED DESCRIPTION OF THE PREFERRED EMBODIMENTS

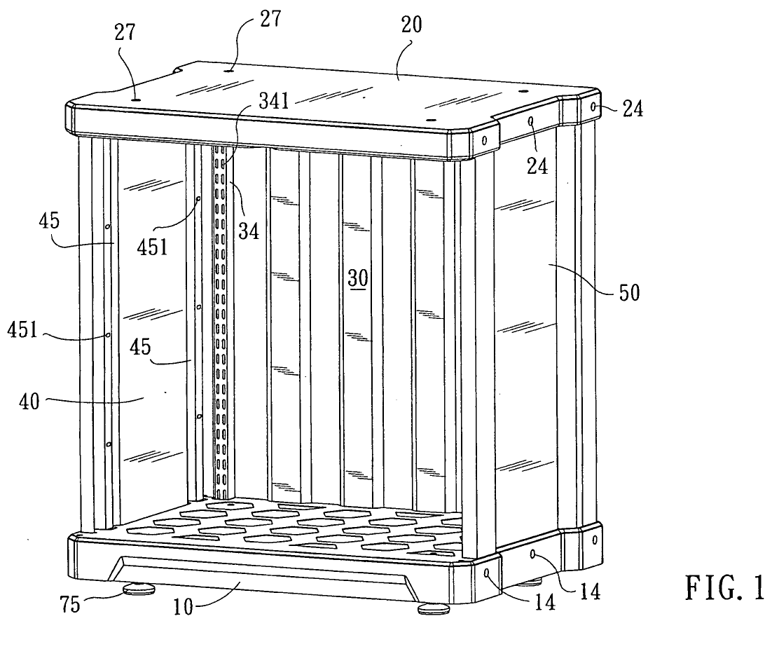

Please refer to FIG. 1. A sectional cabinet according to a preferred embodiment of the present invention is assembled from a bottom wall 10, a top wall 20, a rear wall 30, a left wall 40, and a right wall 50.

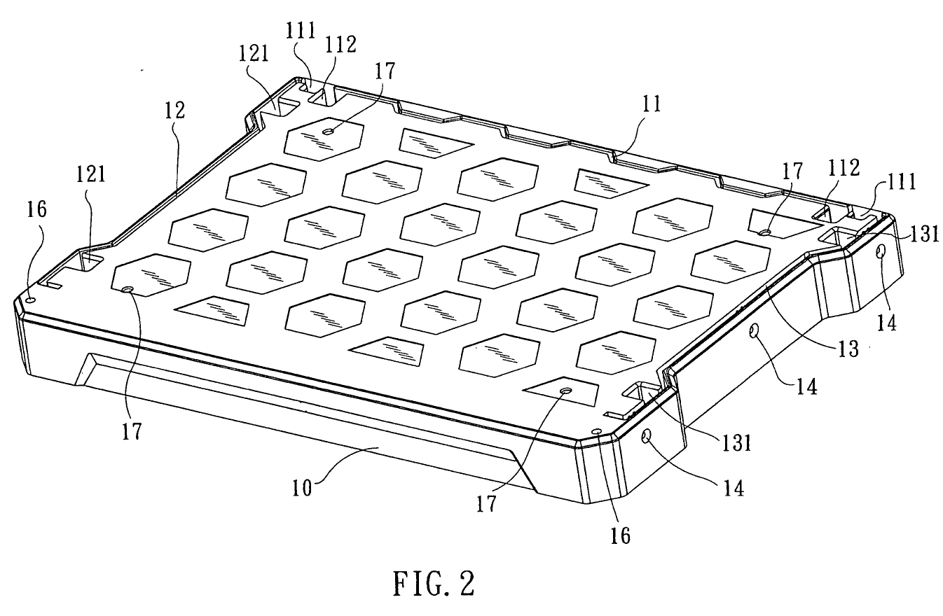

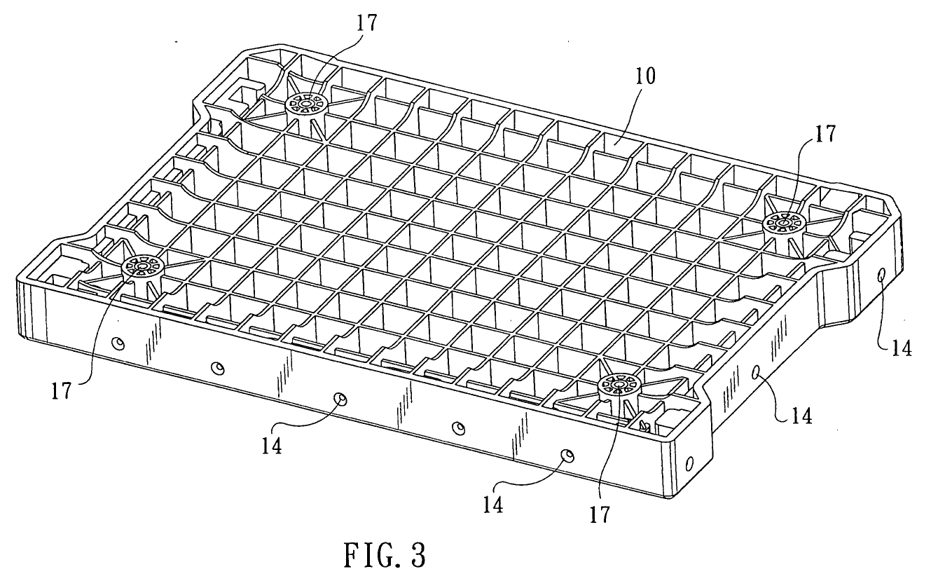

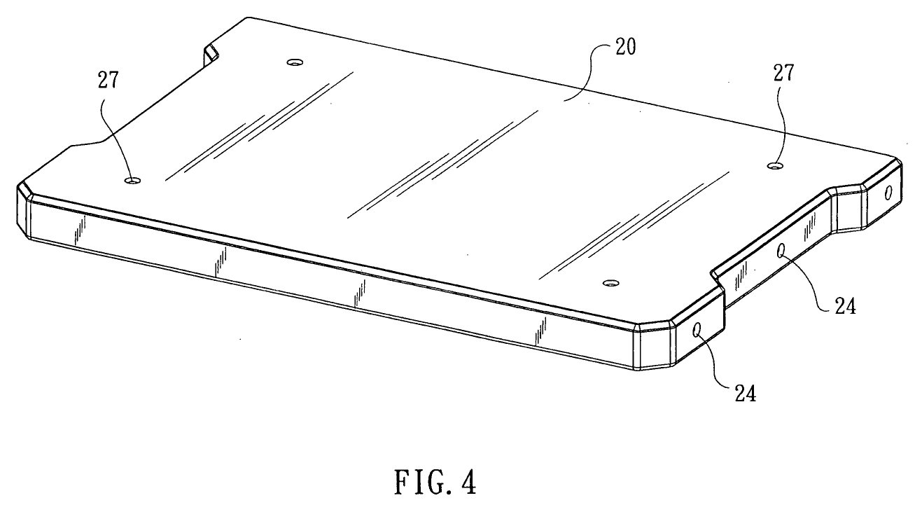

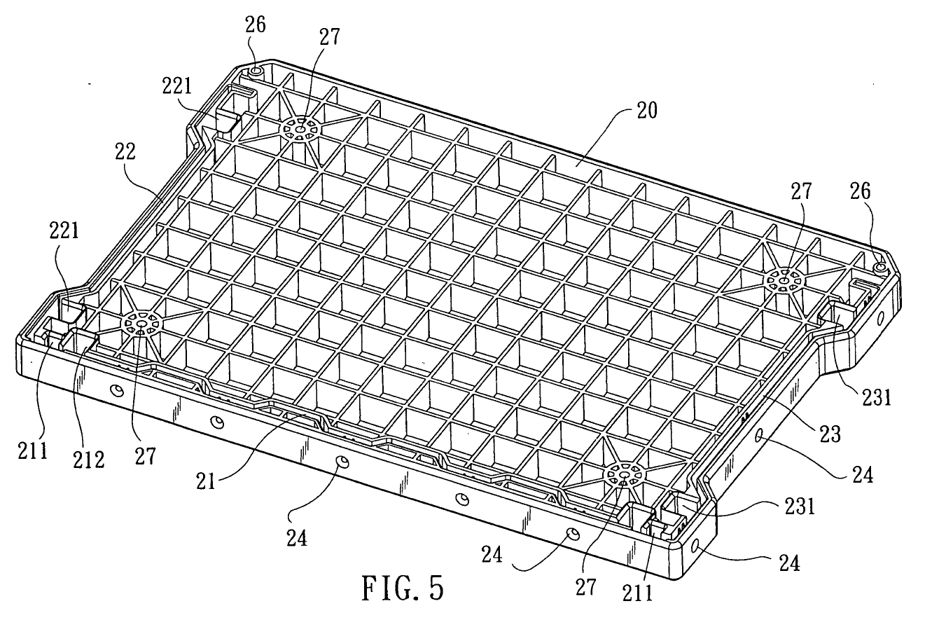

As can be seen from FIGS. 2 and 3, which are top and bottom perspective views, respectively, of the bottom wall 10 for the sectional cabinet of the present invention, the bottom wall 10 is provided on an upper side along a rear, a left, and a right side with a lower rear groove 11, a lower left groove 12, and a lower right groove 13, respectively. The lower left and the lower right groove 12, 13 communicate at respective rear end with a left and a right end of the lower rear groove 11, respectively. As can be seen from FIGS. 4 and 5, which are top and bottom perspective views, respectively, of the top wall 20 for the sectional cabinet of the present invention, the top wall 20 is provided on a lower side along a rear, a left, and a right side with an upper rear groove 21, an upper left groove 22, and an upper right groove 23, respectively. The upper left and the upper right groove 22, 23 communicate at respective rear end with a left and a right end of the upper rear groove 21, respectively. The upper rear, left, and right grooves 21, 22, 23 are corresponding to the lower rear, left, and right grooves 11, 12, 13, respectively.

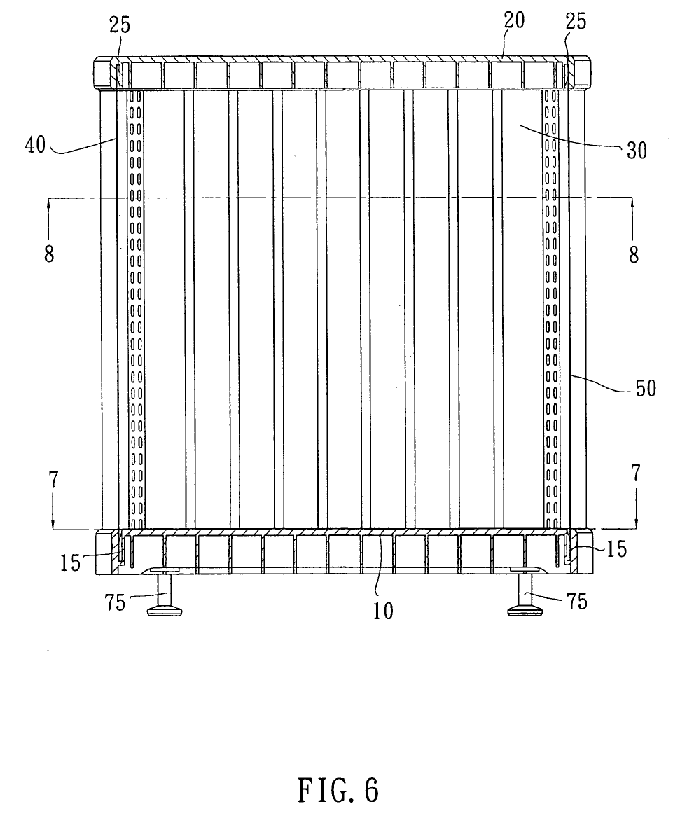

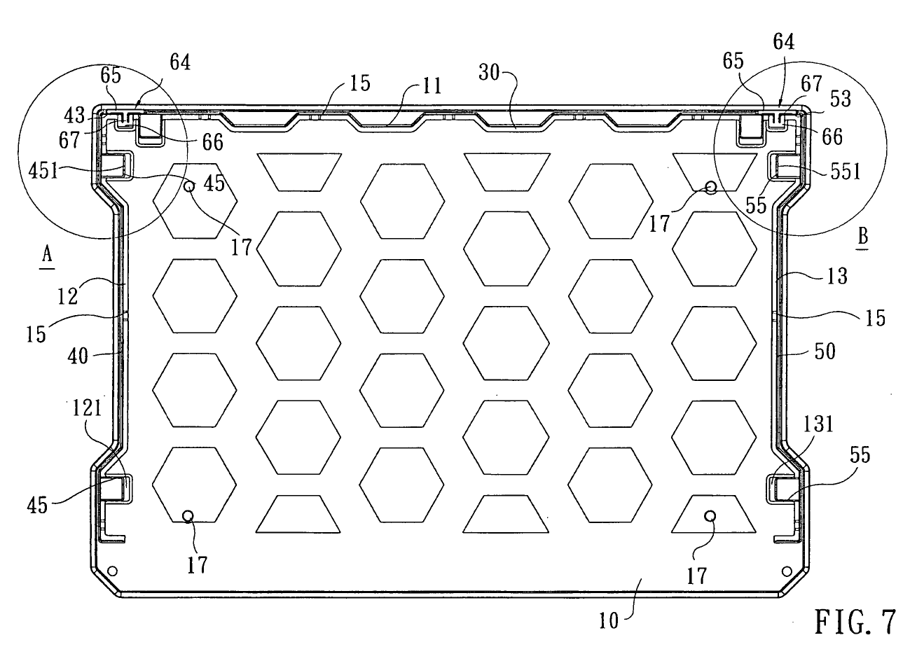

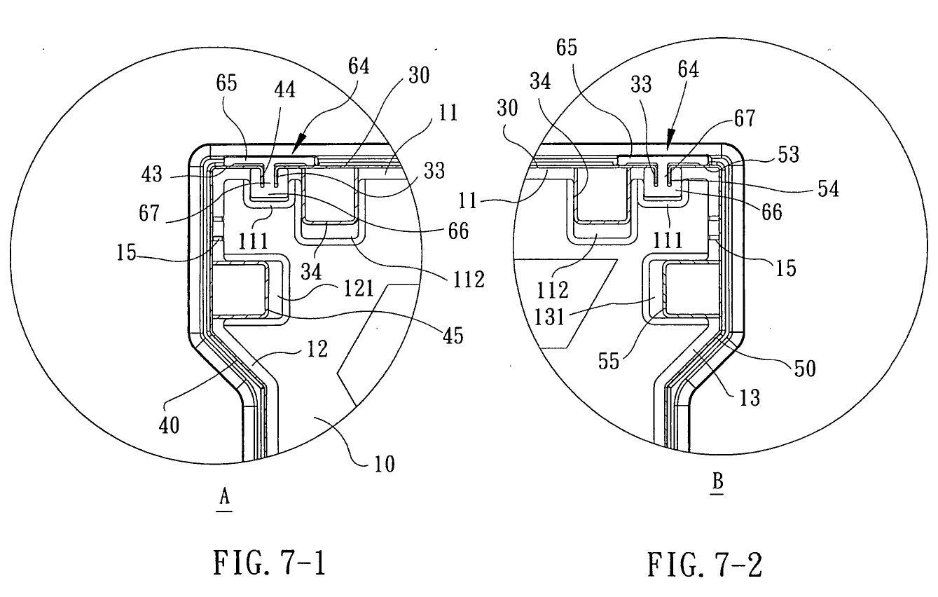

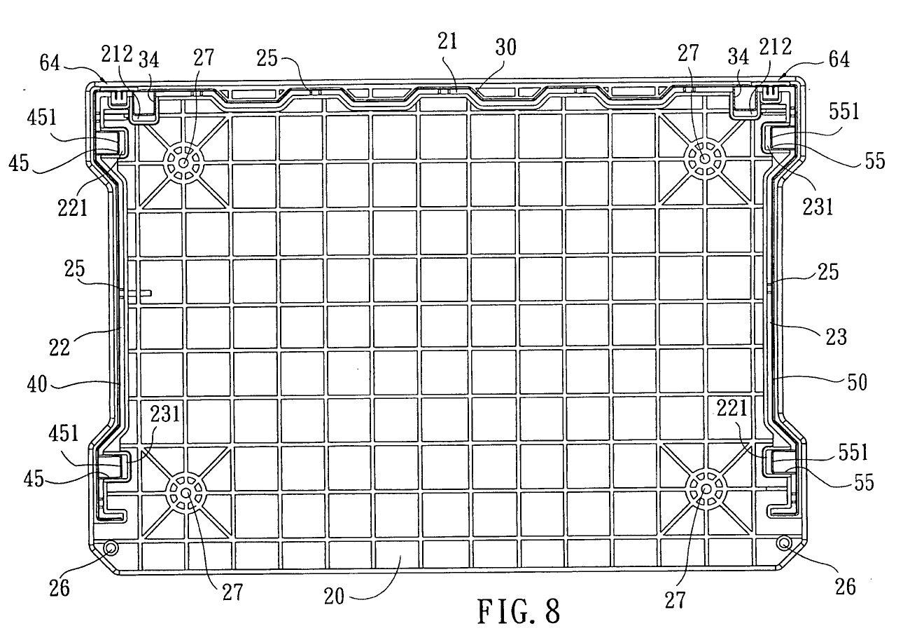

FIG. 6 is a sectioned front view of FIG. 1, FIG. 7 is a cross sectional view taken along line 7-7 of FIG. 6, FIG. 7-1 is an enlarged view of the circled area A of FIG. 7, FIG. 7-2 is an enlarged view of the circled area B of FIG. 7, and FIG. 8 is a cross sectional view taken along line 8-8 of FIG. 6.

Please refer to FIGS. 6 to 8. The rear wall 30 has a lower side inserted in the lower rear groove 11 and an upper side inserted in the upper rear groove 21, the left wall 40 has a lower side inserted in the lower left groove 12 and an upper side inserted in the upper left groove 22, and the right wall 50 has a lower side inserted in the lower right groove 13 and an upper side inserted in the upper right groove 23; further, a rear side of the left wall 40 and a left side of the rear wall 30 are joined together using two connectors 64, and a rear side of the right wall 50 and a right side of the rear wall 30 are joined together using another two connectors 64. Therefore, the bottom wall 10, the top wall 20, the rear wall 30, the left wall 40, and the right wall 50 are joined together to form the sectional cabinet of the present invention.

As can be seen from FIG. 3, the bottom wall 10 is provided along the rear side, the left side, and the right side with a plurality of dowel holes 14 each. In the illustrated preferred embodiment, there are five dowel holes 14 provided at the rear side and three at the left and right sides each. The dowel holes 14 extend through corresponding lower rear, left, and right grooves 11, 12, 13. Similarly, as can be seen from FIG. 5, the top wall 20 is provided along the rear side, the left side, and the right side with a plurality of dowel holes 24 each. In the illustrated preferred embodiment, there are five dowel holes 24 provided at the rear side and three at the left and right sides each. The dowel holes 24 extend through corresponding upper rear, left, and right grooves 21, 22, 23.

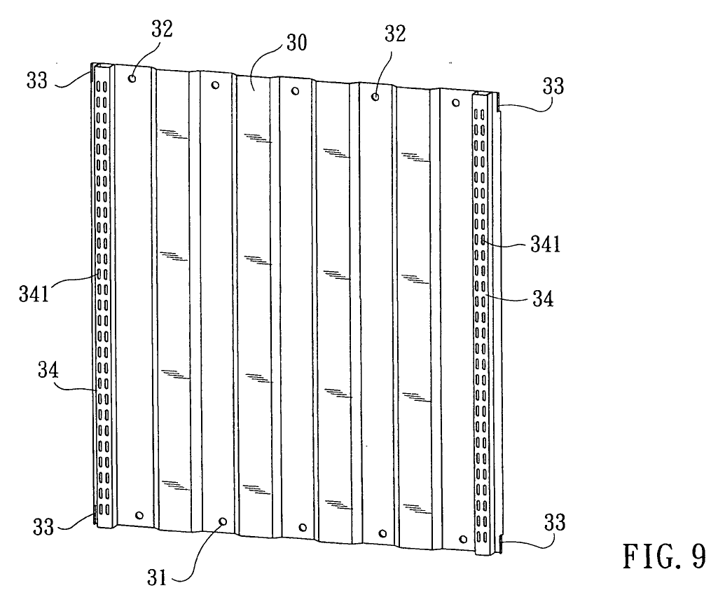

Please refer to FIG. 9. Through holes 31 and 32 are spaced along lower and upper sides, respectively, of the rear wall 30 at positions corresponding to the dowel holes 14, 24 at the rear side of the bottom and the top wall 10, 20.

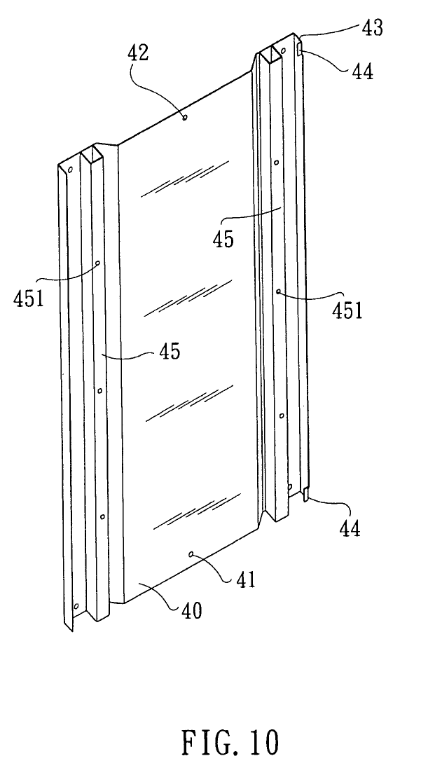

Please refer to FIG. 10. Through holes 41 and 42 are spaced along lower and upper sides, respectively, of the left wall 40 at positions corresponding to the dowel holes 14, 24 at the left side of the bottom and the top wall 10, 20.

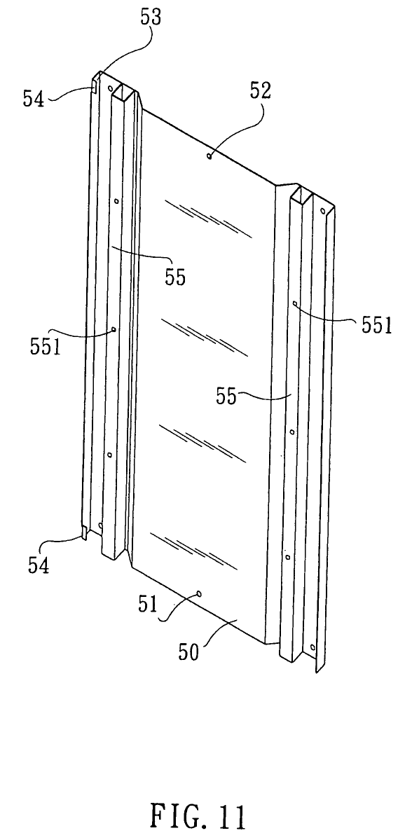

Please refer to FIG. 11. Through holes 51 and 52 are spaced along lower and upper sides, respectively, of the right wall 50 at positions corresponding to the dowel holes 14, 24 at the right side of the bottom and the top wall 10, 20.

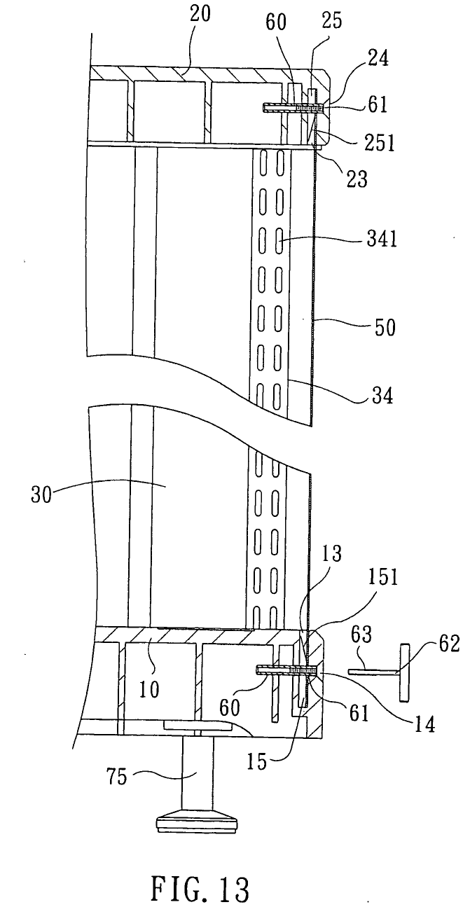

Since the rear wall 30, the left wall 40, and the right wall 50 are connected to the bottom wall 10 and the top wall 20 in the same manner, only the connection of the right wall 50 to the bottom and top walls 10, 20 is described herein with reference to FIG. 13. As can be seen from FIG. 13, the lower and the upper side of the right wall 50 are separately inserted in the lower and the upper right groove 13, 23 on the bottom and the top wall 10, 20, respectively. To secure the right wall 50 to the bottom and the top wall 10, 20, locating dowels 60 are separately extended into the dowel holes 14, 24 at the right sides of the bottom and top walls 10, 20 and the through holes 51, 52 at the lower and upper sides of the right wall 50, respectively, so that the right wall 50 is prevented from separating from the bottom and the top wall 10, 20. The locating dowels 60 each have an inner end slightly smaller than an outer end in the outer diameter thereof to enable easy extending of the locating dowels 60 into the dowel holes 14, 24. Each of the locating dowels 60 is provided at the outer end with an internally threaded axial hole 61. By threading an externally threaded stem 63 of a tool 62 into the threaded axial hole 61 and pulling the tool 62 outward, the locating dowel 60 may be removed from the dowel hole 14, 24, enabling a user to disassemble the sectional cabinet.

As can be seen from FIG. 10, the rear side of the left wall 40 is bent inward to form a rightward joint flange 43. Please refer to FIG. 7-1. The joint flange 43 is linearly aligned with the left side of the rear wall 30. Similarly, as can be seen from FIG. 11, the rear side of the right wall 50 is bent inward to form a leftward joint flange 53. Please refer to FIG. 7-2. The joint flange 53 is linearly aligned with the right side of the rear wall 30. Please refer to FIGS. 7 and 8. Four connectors 64 are provided on the bottom and the top wall 10, 20 near lower and upper ends of the left and the right side of the rear wall 30 for joining the rear wall 30 and the left and right walls 40, 50 together.

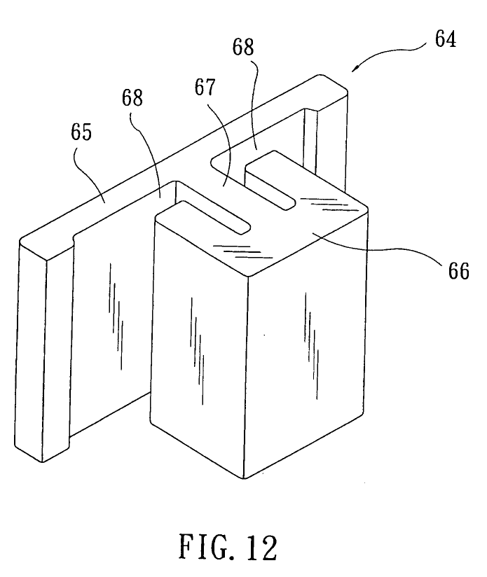

FIG. 12 is a perspective view of the connector 64. As shown, each of the connectors 64 includes a face plate 65, a head portion 66, and a linking portion 67 extended between and connected to the face plate 65 and the head portion 66, such that two transverse spaces 68 are separately formed at two lateral sides of the linking portion 67 between the face plate 65 and the head portion 66, and a longitudinal space 68 is formed between each lateral side of the linking portion 67 and the hear portion 66. The rightward joint flange 43 of the left wall 40 and the left side of the rear wall 30 may be separately inserted into the two transverse spaces 68 of the two connectors 64 arranged near the left side of the rear wall 30; and the leftward joint flange 53 of the right wall 50 and the right side of the rear wall 30 may be separately inserted into the two transverse spaces 68 of the two connectors 64 arranged near the right side of the rear wall 30.

Moreover, as can be seen from FIGS. 10 and 11, a lug 44, 54 is forward projected from each of the lower and upper ends of the joint flange 43, 53 of the left wall 40 and the right wall 50, respectively; and as can be seen from FIG. 9, a lug 33 is forward projected from each of the lower and upper ends of the left and right sides of the rear wall 30. The lugs 33 at the left side of the rear wall 30 and the lugs 44 at the rightward joint flange 43 are separately received in the two longitudinal spaces 68 of the two connectors 64 arranged near the left side of the rear wall 30, and the lugs 33 at the right side of the rear wall 30 and the lugs 54 at the leftward joint flange 53 are separately received in the two longitudinal spaces 68 of the two connectors 64 arranged near the right side of the rear wall 30. Therefore, the rear wall 30 and the left and the right wall 40, 50 are firmly held to one another via the connectors 64.

As can be seen from FIGS. 2 and 5, the lower and upper rear grooves 11, 21 on the bottom and top walls 10, 20, respectively, are provided at positions corresponding to the connectors 64 with a first expanded section 111, 211 each. The connectors 64 are separately inserted in the first expanded sections 111, 211 and thereby held in place on the bottom and top walls 10, 20.

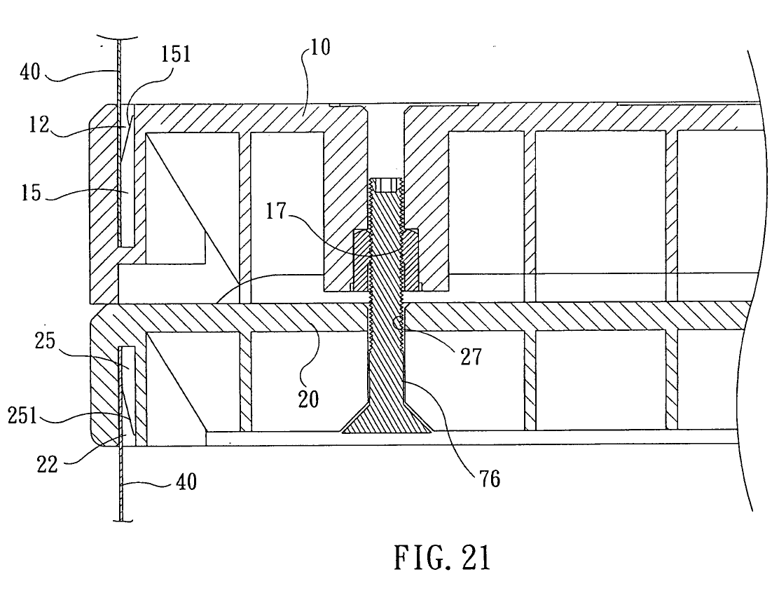

Please refer to FIGS. 6 and 7. The lower rear, left, and right grooves 11, 12, 13 on the bottom wall 10 have configurations the same as that of the rear wall 30, the left wall 40, and the right wall 50, so as to allow the lower sides of the rear, left, and right walls 30, 40, 50 to insert in the grooves 11, 12, 13. For the lower sides of the rear, left, and right walls 30, 40, 50 to be more easily inserted into corresponding grooves 11, 12, 13, the grooves 11, 12, 13 have a width larger than a thickness of the rear, left, and right walls 30, 40, 50. Further, a plurality of guide blocks 15 are provided on inner wall surfaces of the grooves 11, 12, 13, as can be seen from FIGS. 6,7-1, and 7-2. Please refer to FIGS. 13 and 21. A space between the guide blocks 15 and outer wall surfaces of the grooves 11, 12, 13 is the same as the thickness of the rear, left, and right walls 30, 40, 50; and each of the guide blocks 15 has a front end formed into a beveled surface 151 inclined rearward from inner to outer side relative to the grooves 11, 12, 13. With the beveled surfaces 151 at the front ends of the guide blocks 15, the lower sides of the rear, left, and right walls 30, 40, 50 being inserted into the grooves 11, 12, 13 may be easily guided into and tightly held in the spaces between the guide blocks 15 and the outer surfaces of the rear, left, and right walls 30, 40, 50. In the illustrated preferred embodiment, there are six guide blocks 15 provided in the lower left and right grooves 12, 13 on the upper side of the bottom wall 10, and eight in the lower rear groove 11. It is noted the guide blocks 15 are grouped with each group having two closely arranged guide blocks 15.

Please refer to FIGS. 6 and 8. The upper rear, left, and right grooves 21, 22, 23 on the top wall 20 have configurations the same as that of the rear wall 30, the left wall 40, and the right wall 50, so as to allow the upper sides of the rear, left, and right walls 30, 40, 50 to insert in the grooves 21, 22, 23. For the upper sides of the rear, left, and right walls 30, 40, 50 to be more easily inserted into corresponding grooves 21, 22, 23, the grooves 21, 22, 23 have a width larger than a thickness of the rear, left, and right walls 30, 40, 50. Further, a plurality of guide blocks 25 are provided on inner wall surfaces of the grooves 21, 22, 23, as can be seen from FIGS. 6 and 8. Please refer to FIGS. 13 and 21. A space between the guide blocks 25 and outer wall surfaces of the grooves 21, 22, 23 is the same as the thickness of the rear, left, and right walls 30, 40, 50; and each of the guide blocks 25 has a front end formed into a beveled surface 251 inclined rearward from inner to outer side relative to the grooves 21, 22, 23. With the beveled surfaces 251 at the front ends of the guide blocks 25, the upper sides of the rear, left, and right walls 30, 40, 50 being inserted into the grooves 21, 22, 23 may be easily guided into and tightly held in the spaces between the guide blocks 25 and the outer surfaces of the rear, left, and right walls 30, 40, 50. In the illustrated preferred embodiment, there are six guide blocks 25 provided in the upper left and right grooves 22, 23 on the lower side of the top wall 20, and eight in the upper rear groove 21. It is noted the guide blocks 25 are grouped with each group having two closely arranged guide blocks 25.

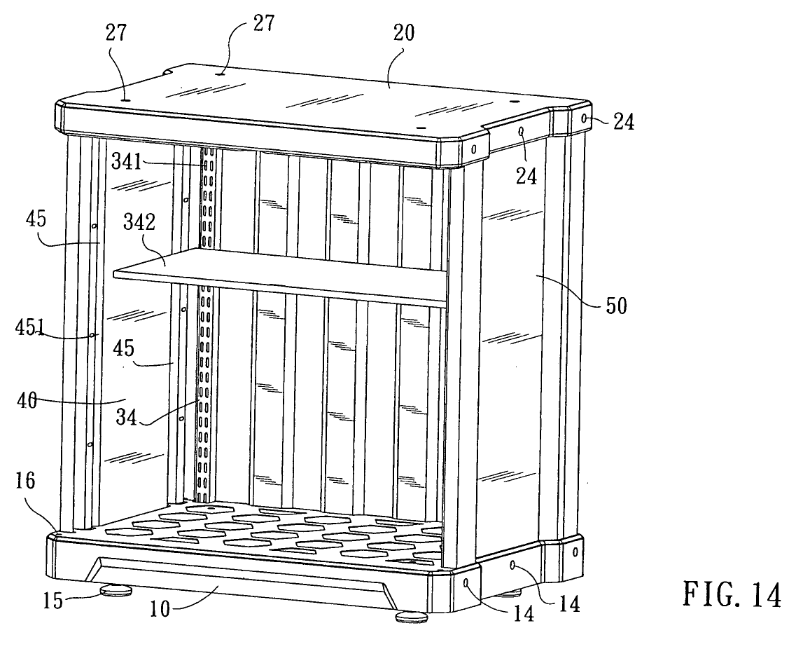

As can be seen from FIG. 9, the rear wall 30 is provided on an inner side thereof with at least two spaced U-sectioned vertical posts 34. Lower and upper ends of the vertical posts 34 are separately inserted in second expanded sections 112, 212 formed in the lower and upper rear grooves 11, 21 of the bottom wall 10 and the top wall 20, respectively, as can be seen from FIGS. 7-1, 7-2, and 8. With the U-sectioned posts 34, the rear wall 30 may have increased structural strength. Please refer to FIG. 14. The U-sectioned posts 34 are provided on a front side with two vertical rows of hanging holes 341 each, so that one or more shafts 342 may be hung to and supported on the posts 34 in the sectional cabinet of the present invention.

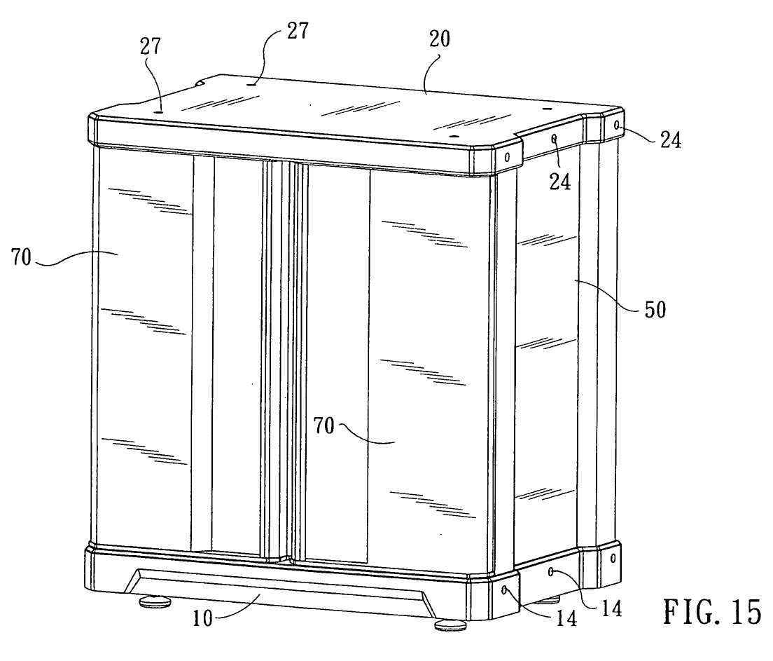

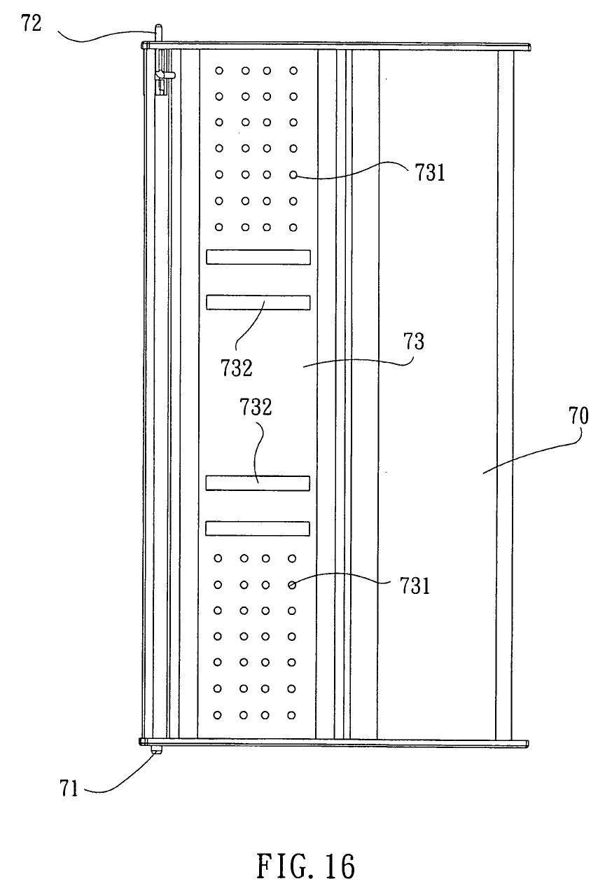

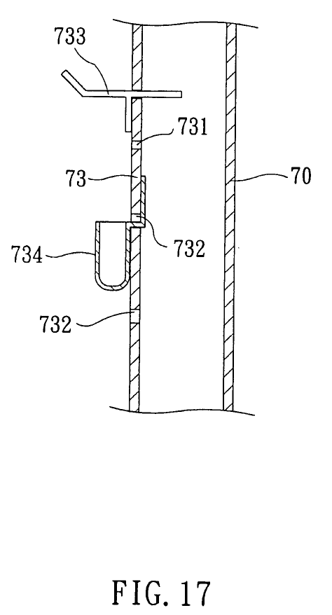

Please refer to FIG. 15. One or more doors 70 may be mounted on the sectional cabinet of the present invention to openably close an open front side of the cabinet. As shown in FIG. 16, one lateral side of the door 70 is provided at a lower end with a downward projected fixed pivot pin 71, and at an upper end with an upward projected retractable pivot pin 72. The fixed pivot pin 71 is inserted into a retaining hole 16 pre-formed on the upper side of the bottom wall 10 (see FIGS. 2 and 14), and the retractable pivot pin 72 is inserted into a retaining hole 26 pre-formed on the lower side of the top wall 20 (see FIGS. 5 and 8), so that the door 70 is pivotally turnable about the pivot pins 71, 72 relative to the sectional cabinet of the present invention. Please refer to FIGS. 16 and 17 at the same time. The door 70 has an inner wall 73, on which a plurality of small holes 731 and a plurality of horizontal slots 732 are formed at predetermined positions for hangers 733 and baskets 734 to hang thereto, respectively.

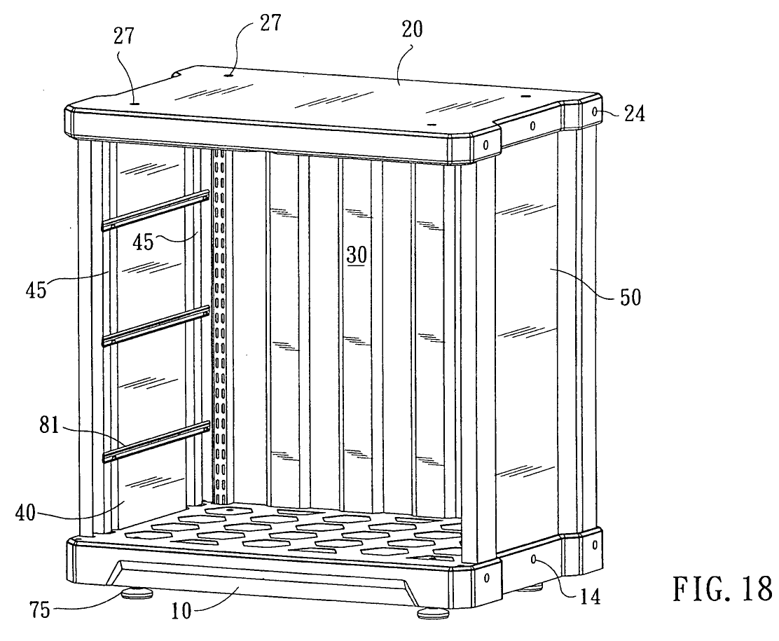

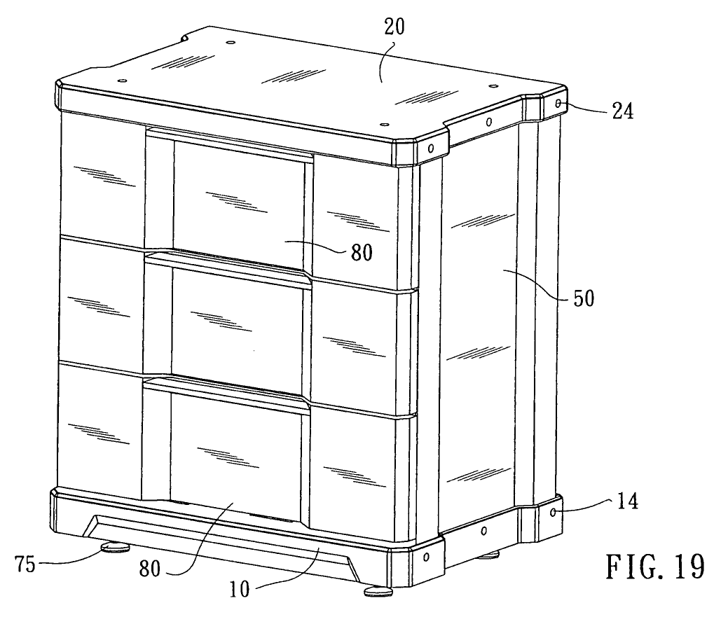

Please refer to FIGS. 10 and 11. The left and the right wall 40, 50 are provided on respective inner side with two spaced U-sectioned vertical posts 45, 55 each. Lower and upper ends of the two U-sectioned vertical posts 45 on the left wall 40 are separately inserted in third expanded sections 121, 221 formed in the lower and upper left grooves 12, 22 (see FIGS. 2 and 5); and lower and upper ends of the two U-sectioned vertical posts 55 on the right wall 50 are separately inserted in third expanded sections 131, 231 formed in the lower and upper right grooves 13, 23 (see FIGS. 2 and 5). With the U-sectioned vertical posts 45, 55, the left and the right wall 40, 50 may have increased structural strength. The vertical posts 45 and the vertical posts 55 are correspondingly provided on their front sides facing toward one another with a plurality of hanging holes 451 and 551, respectively. As shown in FIG. 18, a rail 81 may be horizontally mounted to and between the two vertical posts 45 by connecting two ends of the rail 81 to two hanging holes 451 located at the same height on the two vertical posts 45; and similarly, a rail 81 may be horizontally mounted to and between the two vertical posts 55 by connecting two ends of the rail 81 to two hanging holes 551 located at the same height on the two vertical posts 55. A drawer 80 may be then slidably supported on two rails 81 mounted on the left and the right wall 40, 50 at the same height, as shown in FIG. 19. Since the mounting of the rails 81 and the drawer 80 is a known skill, it is not discussed in details herein.

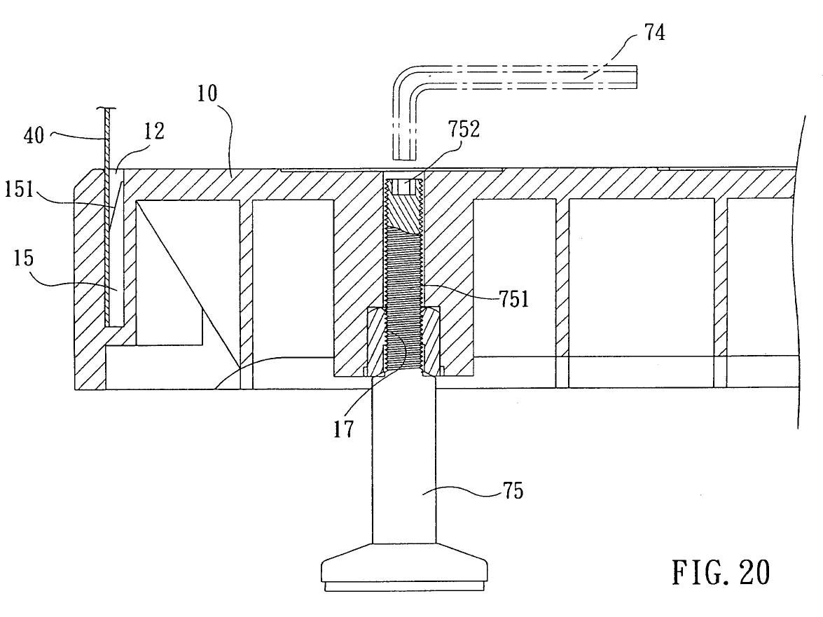

Please refer to FIGS. 2, 3 and 20. The bottom wall 10 is provided near four corners thereof with an internally threaded hole 17 each. A foot 75 or a caster (not shown) may be upwardly screwed to each of the threaded holes 17. An externally threaded portion 751 of the foot 75 has a hexagonal hole 752 axially formed at a free end thereof. An operator may insert a hex wrench 74 into the hexagonal hole 752 from the upper side of the bottom wall 10 to turn the foot 75 and thereby adjusts the foot 75 to different height.

Please refer to FIG. 21 along with FIGS. 1, 4, and 5. The top wall 20 is provided at positions corresponding to the threaded holes 17 of the bottom wall 10 with four through holes 27. Two sectional cabinets of the present invention may be vertically stacked and secured to each other by extending four locating screws 76 into the aligned holes 17 and 27.

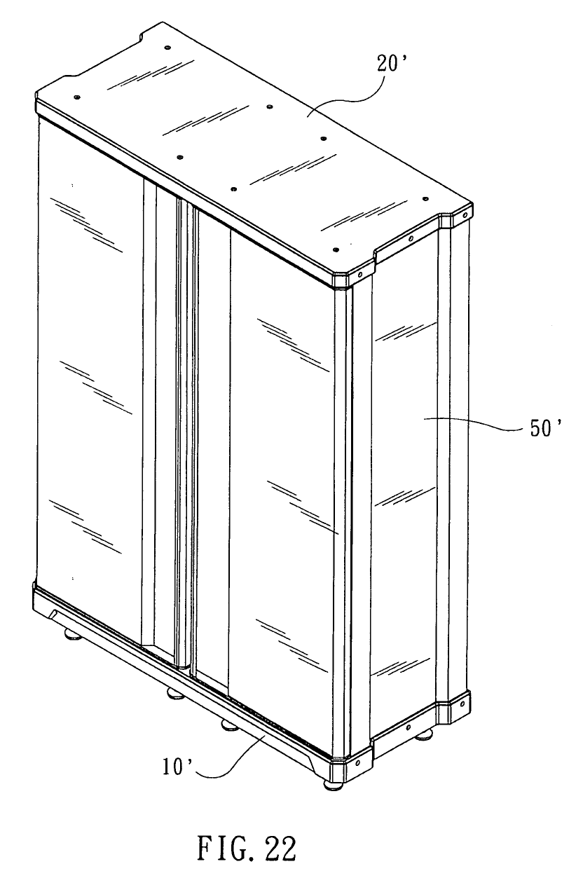

In the illustrated preferred embodiment of the sectional cabinet of the present invention, there is only one piece of rear wall 30. FIG. 22 shows another sectional cabinet according to a second embodiment of the present invention. The sectional cabinet in the second embodiment includes a bottom wall 10′ and a top wall 20′ having increased length to provide an increased inner space of the cabinet, a left wall (not shown) and a right wall 50′ having a width the same as that of the left and right walls 40, 50 in the preferred embodiment but an increased height, and two rear walls (not shown) being laterally joined together. The two rear walls may be joined together at lower and upper ends of two adjacent sides thereof using the above-mentioned connectors 64.

It is noted the sectional cabinet of the present invention can be easily assembled without the need of any tool. To assemble the sectional cabinet of the present invention, simply insert lower and upper sides of the rear, the left, and the right wall into the grooves correspondingly provided on the bottom wall and the top wall, and then insert the locating dowels into the dowel holes provided on the bottom wall and the top wall to complete the assembly. The sectional cabinet of the present invention may also have doors, shelves, and drawers assembled thereto, making it more convenient for storing and organizing different things.

What is claimed is:

1. A sectional cabinet, comprising:
a bottom wall being provided on an upper side along a rear, a left, and a right side with a lower rear groove, a lower left groove, and a lower right groove, respectively; the lower left groove and the lower right groove communicating at respective rear end with a left and a right end of the lower rear groove, respectively; and the bottom wall also being provided along the rear, the left, and the right side with at least two spaced dowel holes each to extend through the lower rear, left, and right grooves;
a top wall being provided on a lower side along a rear, a left, and a right side with an upper rear groove, an upper left groove, and an upper right groove, respectively, corresponding to the lower rear groove, the lower left groove, and the lower right groove on the bottom wall; and the top wall also being provided along the rear, the left, and the right side with at least two spaced dowel holes each to extend through the upper rear, left, and right grooves;
a rear wall having a lower side inserted in the lower rear groove of the bottom wall, and an upper side inserted in the upper rear groove of the top wall; and the rear wall having a plurality of through holes formed at positions corresponding to the dowel holes on the rear sides of the bottom wall and the top wall;
a left wall having a lower side inserted in the lower left groove of the bottom wall, and an upper side inserted in the upper left groove of the top wall; a rear side of the left wall and a left side of the rear wall being joined together; and the left wall having a plurality of through holes formed at positions corresponding to the dowel holes on the left sides of the bottom wall and the top wall;
a right wall having a lower side inserted in the lower right groove of the bottom wall, and an upper side inserted in the upper right groove of the top wall; a rear side of the right wall and a right side of the rear wall being joined together; and the right wall having a plurality of through holes formed at positions corresponding to the dowel holes on the right sides of the bottom wall and the top wall; and
a plurality of locating dowels for extending into the dowel holes on the bottom wall and the top wall, as well as the corresponding through holes on the rear wall, the left wall, and the right wall.

2. The sectional cabinet as claimed in claim 1, further comprising four connectors separately provided on the bottom and the top wall near lower and upper ends of the left and the right side of the rear wall for joining the rear wall and the left and right walls together; and wherein each of the connectors includes a face plate, a head portion, and a link portion extended between and connected to the face plate and the head portion, such that two transverse spaces are formed at two lateral sides of the linking portion between the face plate and the head portion, and a longitudinal space is formed between each lateral side of the linking portion and the hear portion; the rear side of the left wall and the left side of the rear wall being separately inserted into the two transverse spaces of the two connectors arranged near the left side of the rear wall; and the rear side of the right wall and the right side of the rear wall being separately inserted into the two transverse spaces of the two connectors arranged near the right side of the rear wall.

3. The sectional cabinet as claimed in claim 2, wherein the rear sides of the left wall and the right wall are bent inward to form a rightward joint flange and a leftward joint flange, respectively, and the rightward and leftward flanges being linearly aligned with the left side and the right side of the rear wall, respectively; a lug being forward projected from each of the lower and upper ends of the rightward and the leftward joint flange of the left wall and the right wall, respectively, and a lug being forward projected from each of the lower and upper ends of the left and right sides of the rear wall; the lugs at the left side of the rear wall and the lugs at the rightward joint flange of the left wall being separately received in the two longitudinal spaces of the two connectors arranged near the left side of the rear wall, and the lugs at the right side of the rear wall and the leftward joint flange of the right wall being separately received in the two longitudinal spaces of the two connectors arranged near the right side of the rear wall.

4. The sectional cabinet as claimed in claim 2, wherein the connectors are separately inserted in the lower rear groove of the bottom wall and the upper rear groove of the top wall at predetermined positions.

5. The sectional cabinet as claimed in claim 1, wherein the lower rear, left, and right grooves on the bottom wall have configurations the same as that of the rear, left, and right walls, respectively, and a width larger than a thickness of the rear, left, and right walls; and wherein the lower rear, left, and right grooves on the bottom wall have a plurality of guide blocks provided on inner wall surfaces thereof; a space between the guide blocks and outer wall surfaces of the lower rear, left, and right grooves being the same as the thickness of the rear, left, and right walls; and each of the guide blocks having a front end formed into a beveled surface inclined rearward from inner to outer side relative to the lower rear, left, and right grooves.

6. The sectional cabinet as claimed in claim 1, wherein the upper rear, left, and right grooves on the top wall have configurations the same as that of the rear, left, and right walls, respectively, and a width larger than a thickness of the rear, left, and right walls; and wherein the upper rear, left, and right grooves on the top wall have a plurality of guide blocks provided on inner wall surfaces thereof; a space between the guide blocks and outer wall surfaces of the upper rear, left, and right grooves being the same as the thickness of the rear, left, and right walls; and each of the guide blocks having a front end formed into a beveled surface inclined rearward from inner to outer side relative to the upper rear, left, and right grooves.

7. The sectional cabinet as claimed in claim 1, wherein the rear wall is provided on an inner side thereof with at least two spaced U-sectioned vertical posts;
and lower and upper ends of the U-sectioned vertical posts being separately inserted in the lower and upper rear grooves on the bottom and the top wall, respectively.

8. The sectional cabinet as claimed in claim 7, wherein each of the U-sectioned vertical posts on the rear wall is provided on a front side thereof with at least one vertical row of hanging holes.

9. The sectional cabinet as claimed in claim 1, further comprising at least one door openably closing an open front side of the sectional cabinet; the door being provided at a lower end of one lateral side with a downward projected fixed pivot pin, and at an upper end of the same lateral side with an upward projected retractable pivot pin; the fixed pivot pin being inserted in a retaining hole pre-formed on the upper side of the bottom wall, and the retractable pivot pin being inserted in a retaining hole pre-formed on the lower side of the top wall, so that the door is pivotally turnable about the fixed and retractable pivot pins relative to the sectional cabinet.

10. The sectional cabinet as claimed in claim 1, wherein the left and right walls are provided on respective inner side with two spaced U-sectioned vertical posts each; lower and upper ends of the two U-sectioned vertical posts on the left wall being separately inserted in the lower and upper left grooves on the bottom wall and the top wall, respectively; and lower and upper ends of the two U-sectioned vertical posts on the right wall being separately inserted in the lower and upper right grooves on the bottom wall and the top wall, respectively.

11. The sectional cabinet as claimed in claim 1, further comprising at least one drawer and at least two laterally corresponding rails; and wherein the left and right walls are provided on respective inner side with two spaced U-sectioned vertical posts each; lower and upper ends of the two U-sectioned vertical posts on the left wall being separately inserted in the lower and upper left grooves on the bottom wall and the top wall, respectively; and lower and upper ends of the two U-sectioned vertical posts on the right wall being separately inserted in the lower and upper right grooves on the bottom wall and the top wall, respectively; the U-sectioned vertical posts on the left wall and the right wall being correspondingly provided on front sides facing toward one another with at least one hanging hole each; the at least two rails being separately mounted to the left and the right wall with two ends of each rail connected to two hanging holes formed at the same height on the same wall; and the drawer being slidably supported on the at least two rails.
